(19) United States
(12) Patent Application Publication
(10) Pub. No.: US 2018/0311696 A1
(43) Pub. Date: Nov. 1, 2018

(54) PAINTING BOOTH

(71) Applicant: TRINITY INDUSTRIAL CORPORATION, Toyota-shi, Aichi (JP)

(72) Inventors: Ryota SAITO, Toyota-shi (JP); Hideaki HARA, Obu-shi (JP)

(73) Assignee: TRINITY INDUSTRIAL CORPORATION, Toyota-shi, Aichi (JP)

(21) Appl. No.: 15/772,794

(22) PCT Filed: Sep. 14, 2016
(86) PCT No.: PCT/JP2016/077094

§ 371 Date: May 1, 2018

(30) Foreign Application Priority Data
Nov. 12, 2015 (JP) 2015-222284

(51) Int. Cl. B05B 16/00; B05B 13/04; B05B 14/44

(52) U.S. Cl. CPC B05B 16/00; B05B 12/18; B05B 14/44; B05B 13/0452

(57) ABSTRACT

A painting booth includes a pair of first inner surfaces facing each other in a first horizontal direction with a painting treatment area therebetween and a pair of first inclined ceiling surfaces inclined downward from a position close to a center, in the first horizontal direction, in an upper part of the inside to an upper end part of each of the pair of first inner surfaces. An air supply duct is disposed at a center of the upper part of the inside, and a side air blow-out port is provided on the air supply duct to blow air against the pair of first inclined ceiling surfaces.

### TECHNICAL FIELD

The present invention relates to a painting booth which has, in the inside thereof, a painting treatment area where a workpiece is coated with atomized paint, and in which air flows down from an air supply unit provided at the upper part of the inside so as to remove atomized paint not attached to the workpiece.

### BACKGROUND ART

As a painting booth of this type, there is conventionally known a painting booth in which an entire ceiling is configured with a mesh and a filter mat stacked on the mesh, and air flows downward in the vertical direction from the entire ceiling while the ceiling space is pressurized (for example, see Patent Document 1).

### RELATED ART DOCUMENTS

### Patent Documents

Patent Document 1: Japanese Patent Application Laid-Open No. H8-266988 (FIGS. 1 to 3)

### SUMMARY OF INVENTION

### Problems to be Solved by the Invention

Meanwhile, a coating gun used in a painting booth has a structure in which air called shaping air is blown out so as to atomize paint. In recent years, electrostatic coating guns have been improved to reduce a blowing pressure of the shaping air. In contrast, if a flowing speed of the air flowing down in the painting booth is the same as before, the atomized paint sprayed from the coating gun is blown away downward before attaching to a workpiece. To address this issue, the flow rate of the air flowing down in the painting booth is also reduced in order to reduce the flowing speed of the air. However, there is a problem that when the flow rate of the air is simply reduced in the conventional painting booth, an internal pressure in the ceiling space becomes too low to stably control the flow rate of the air flowing down in the painting booth.

The present invention has been made in view of the above circumstances, and an object of the present invention is to provide a painting booth in which the flow rate of air flowing down in a painting booth can be stably controlled.

### Means of Solving the Problems

In order to achieve the above object, a painting booth according to the present invention is a painting booth having therein a painting treatment area where a workpiece is painted with atomized paint, in which air flows down from an upper part of an inside of the painting booth to remove the atomized paint that is not attached to the workpiece. The painting booth includes, a pair of first inner surfaces facing each other in a first horizontal direction with the painting treatment area therebetween, a pair of first inclined ceiling surfaces each inclined downward from a position close to a center, in the first horizontal direction, in the upper part of the inside to an upper end part of each of the pair of first inner surfaces, an air supply unit disposed at the center, in the first horizontal direction, of the upper part of the inside, and a side air blow-out unit provided on the air supply unit to blow air against the pair of first inclined ceiling surfaces.

Further, a painting booth according to the present invention is a painting booth having therein a painting treatment area where a workpiece is painted with atomized paint, in which air flows down from an upper part of an inside of the painting booth to remove the atomized paint that is not attached to the work. The painting booth includes a side-part surrounding wall which has a cylindrical shape and laterally surrounds the painting treatment area, a conical ceiling wall which is inclined and narrowed from an entire part of an upper end of the side-part surrounding wall toward above a central part of the side-part surrounding wall, an air supply unit disposed on a central part of an upper part of the conical ceiling wall, and a side air blow-out unit provided on the air supply unit to blow air against the conical ceiling wall.

### BRIEF DESCRIPTION OF THE DRAWINGS

FIG. 1 is a perspective view of a painting booth according to a first embodiment of the present invention;

FIG. 2 is a sectional side view of the painting booth at an intermediate position in a longitudinal direction;

FIG. 3 is a sectional side view of the painting booth at an intermediate position in a transverse direction;

FIG. 4 is a partially enlarged sectional side view of an air supply unit;

FIG. 5 is a perspective view of a painting booth according to a second embodiment;

FIG. 6 is a sectional side view of a painting booth according to a modified example of the present invention; and

FIG. 7 is a partially enlarged sectional side view of an air supply unit according to a modified example of the present invention.

### MODE FOR CARRYING OUT THE INVENTION

### First Embodiment

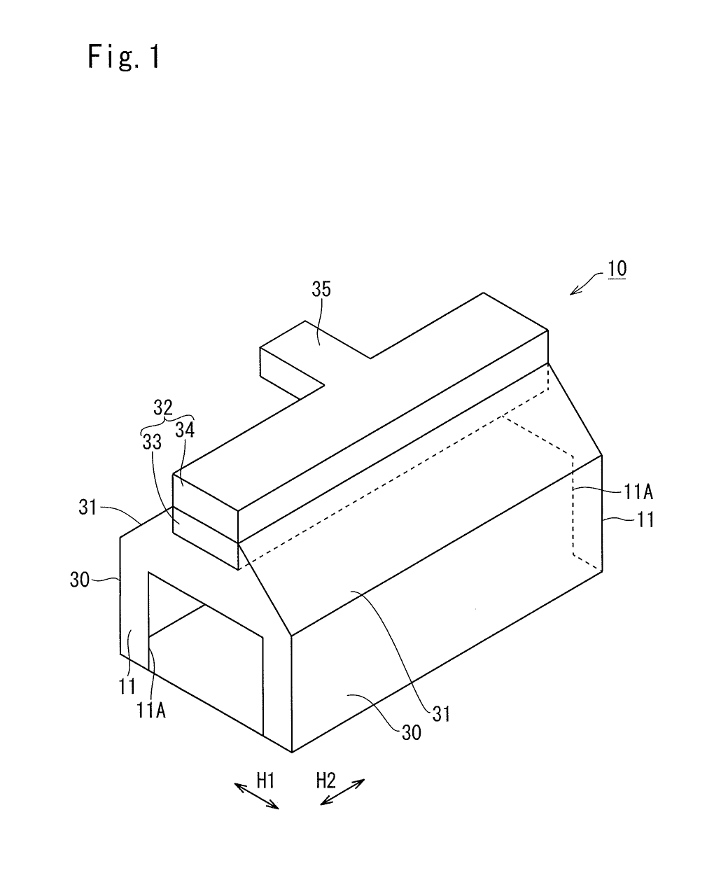

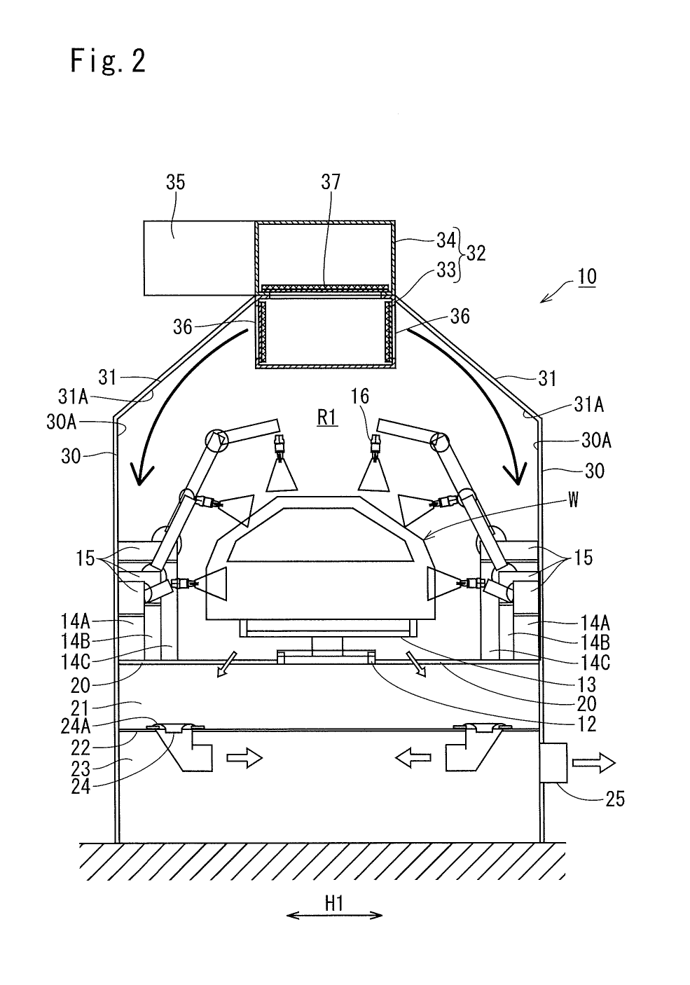

Hereinafter, an embodiment of the present invention will be described with reference to FIGS. 1 to 4. As shown in FIG. 1, a painting booth 10 of the present embodiment has a rectangular planar shape. The transverse direction of the rectangle is a first horizontal direction H1 according to the present invention, and the longitudinal direction of the rectangle is a second horizontal direction H2 according to the present invention. In each of a pair of shorter-side side walls 11 facing each other in the second horizontal direction H2 (longitudinal direction) in the painting booth 10, each of carry-in/out ports 11A and 11A is formed. Further, a conveyance passage 12 shown in FIG. 2 passes through the both carry-in/out ports 11A and 11A, and a conveyor carriage 13 carrying a workpiece W such as a vehicle body moves in one direction on the conveyance passage 12 and passes inside the painting booth 10.

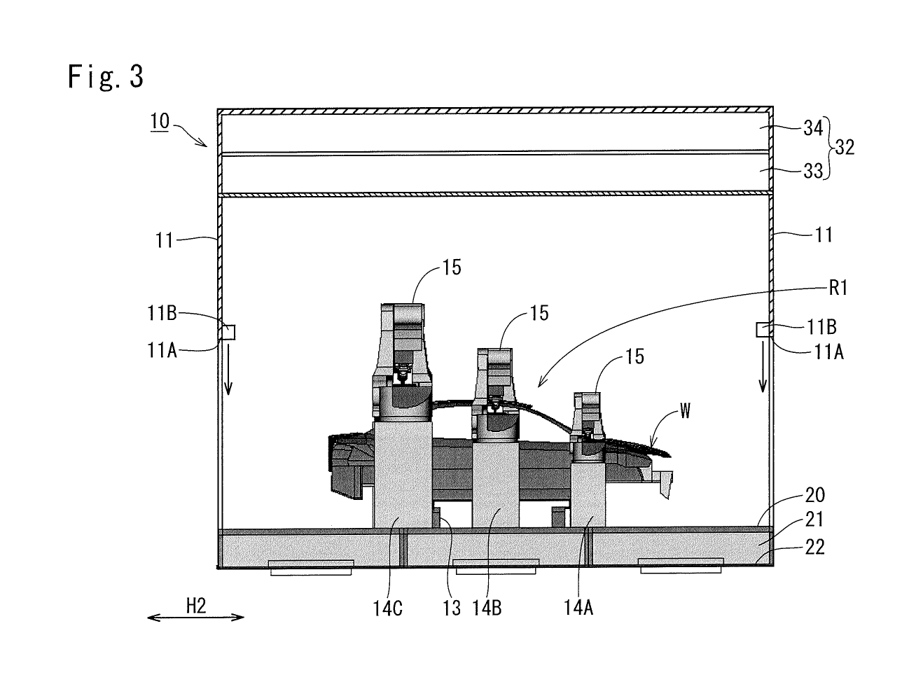

On an upper opening edge of each carry-in/out port 11A in the painting booth 10, an air curtain generator 11B (see FIG. 3) having, for example, a plurality of air nozzles laterally arranged is attached, so that the carry-in/out port 11A is covered by an air curtain.

As shown in FIG. 2, duckboards 20 are provided on the both sides of the conveyance passage 12 in the painting booth 10. On the duckboards 20, a plurality of support platforms 14A, 14B, and 14C having different sizes of large, medium, and small are provided as shown in FIG. 3. A coating robot 15 is mounted on each of the support platforms 14A, 14B, and 14C, and the workpiece W is painted in a painting treatment area R1 surrounded by the group of coating robots 15.

Specifically, the support platforms 14A, 14B, and 14C each have, for example, a pillar shape extending straight in the vertical direction, and are arranged at intervals in the second horizontal direction H2 while being adjacent to a pair of longer-side side walls 30 and 30 of the painting booth 10 in the first horizontal direction H1 as shown in FIG. 2. Further, each coating robot 15 is a so-called vertical articulated robot and is serially equipped with a first arm, a second arm, and a wrist on a horizontally rotatable pivot base. An electrostatic coating gun 16 is mounted on the top end part of the wrist. The coating gun 16 has the same structure as, for example, one disclosed in Japanese Patent Application Laid-Open No. 2013-166113 and sprays atomized paint in a charged state so that the atomized paint is attached to the workpiece W by using attraction force of static electricity.

An underfloor room 21 is formed below the duckboards 20, and further below the underfloor room 21, a suction room 23 which is separated from the underfloor room 21 by an underfloor separation plate 22 is formed. Further, a plurality of communication holes 24 are formed in the both side parts, in the first horizontal direction H1, of the underfloor separation plate 22, and an annular ridge 24A protrudes upward from the opening edge of each of the communication holes 24. Then, air is suctioned through an exhaust duct 25 communicated to the suction room 23 while water is reserved on the upper surface of the underfloor separation plate 22, up to the height of the annular ridge 24A. A flow rate of the air being suctioned is approximately the same as the flow rate of air blown out into the painting booth 10 from a first duct 33 which will be described later.

As shown in FIG. 2, an upper part of the inside of the painting booth 10 is configured to have two stage duct 32 between a pair of inclined roofs 31 and 31. The pair of inclined roofs 31 and 31 each have a flat plate shape and are inclined such that the inclined roofs 31 and 31 are raised from the upper end parts of the pair of longer-side side walls 30 and 30 toward the position close to the center, in the first horizontal direction H1, of the painting booth 10. Further, a pair of first inclined ceiling surfaces 31A and 31A of the present invention and a pair of first inner surfaces 30A and 30A of the present invention intersect each other at an angle of, for example, approximately 45 degrees. The first inclined ceiling surfaces 31A and 31A are inner surfaces of the pair of inclined roofs 31 and 31, and the first inner surfaces 30A and 30A are inner surfaces of the pair of longer-side side walls 30 and 30.

The two stage duct 32 is configured such that a second duct 34 having a laterally elongated rectangular cross-section is stacked on a first duct 33 having the same shape. A junction surface between the first duct 33 and the second duct 34 is located, for example, just at upper end parts of the inclined roofs 31 and 31, the first duct 33 protrudes downward in the painting booth 10 and is disposed between the upper end parts of the inclined roofs 31 and 31, and the second duct 34 protrudes above the painting booth 10.

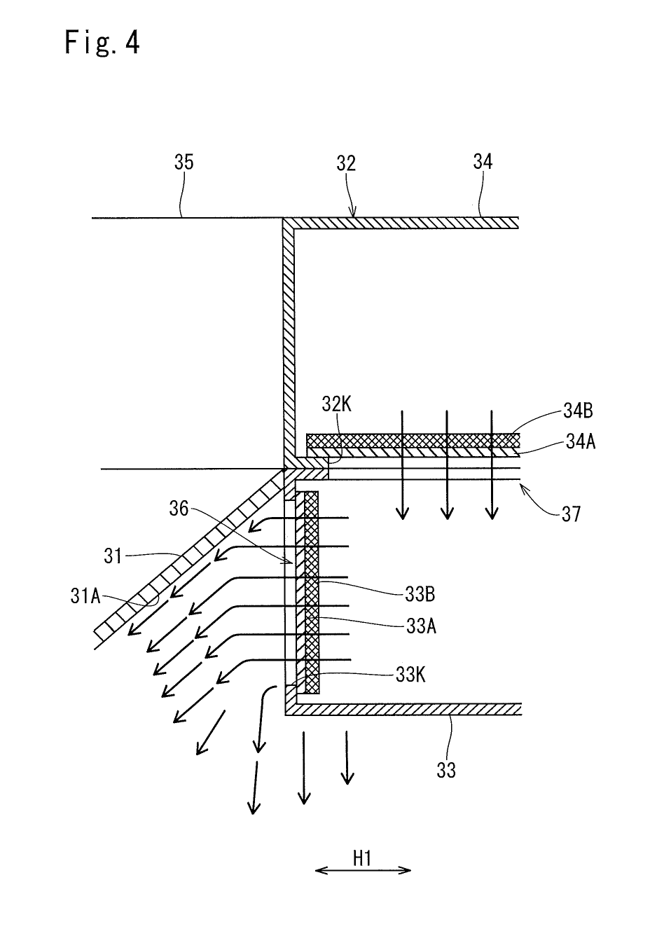

The first duct 33 corresponds to an “air supply unit” and an “air supply duct” according to the present invention, and side air blow-out units 36 and 36 according to the present invention are provided on both side surfaces of the first duct 33. Specifically, an approximately entire part, except the upper and lower edge parts, of each of the both side walls of the first duct 33 is cut off at a plurality of positions, in a longitudinal direction, of the first duct 33, so that a plurality of communication ports 33K are formed, in a longitudinal direction, in the entire first duct 33 as shown in FIG. 4. Further, a mesh 33A is laid on an approximately entire part of the inner surface of each of the both side walls of the first duct 33, and a filter mat 33B is laid on the inside of the mesh 33A in an overlapping manner, so that the approximately entire part of the both side surfaces of the first duct 33 functions as the side air blow-out units 36 and 36.

In the present embodiment, an “air-permeable pressure reduction member” according to the present invention is configured with the mesh 33A and the filter mat 33B.

In a part on which the first duct 33 and the second duct 34 are stacked on each other, an air passing part 37 having the same configuration as the side air blow-out unit 36 is provided. That is, the air passing part 37 has a plurality of communication ports 32K formed in a part where the first duct 33 and the second duct 34 are stacked on each other, and the communication ports 32K are covered by a mesh 34A and a filter mat 34B.

Further, as shown in FIG. 1, an introduction part 35 is provided approximately at the center, in the longitudinal direction, of one side surface of the second duct 34, and an air conditioner (not shown) is connected to the introduction part 35. The air conditioner conditions air, in which external air is mixed with air suctioned through the exhaust duct 25 described above, to a predetermined humidity and temperature through heating, cooling, humidifying, or other treatments, and then feeds the air to the second duct 34.

The configuration of the painting booth 10 of the present embodiment is described above. Next, an operation and effect of the painting booth 10 will be described. When the painting booth 10 is made to operate, compressed air fed from the air conditioner is once taken into the second duct 34 shown in FIG. 2, then passes through an air passing part 37, and is taken into the first duct 33 corresponding to an “air supply unit” of the present invention. Here, in the second duct 34, there can be a large difference in internal pressure between an introduction part 35 for taking air in from the air conditioner and a part distant from the introduction part 35. However, inside the first duct 33, air is taken in through the air passing part 37 from the entire part, in the longitudinal direction, of the second duct 34, and thus, the variation of the internal pressure depending on the position in the first duct 33 is reduced compared with the variation in the second duct 34 and is approximately uniform. Thus, the air is blown out through the pair of side air blow-out units 36 and 36, depending on the internal pressure in the first duct 33, and is blown against the both of the first inclined ceiling surfaces 31A and 31A.

Then, the air is directed obliquely downward while being guided by the first inclined ceiling surfaces 31A and 31A as shown in FIG. 4. The air reaches the first inner surfaces 30A and 30A, which are the inner surfaces of the longer-side side walls 30 and 30, and then is directed downward in the vertical direction as shown in FIG. 2. Then, the air passes through around the coating robots 15 and the support platforms 14A, 14B, and 14C is suctioned down below the duckboards 20. At that time, the atomized paint around the coating robots 15 and the support platforms 14A, 14B, and 14C is also suctioned down below the duckboards 20. Further, in the painting treatment area R1 surrounded by the group of coating robots 15, the air flows down around the painting treatment area R1 as described above, and the atomized paint slowly flows downward along with the air flowing down. Thus, the atomized paint which is not attached to the workpiece W in the painting treatment area R1 is also ejected downward below the duckboards 20.

In the painting booth 10 of the present embodiment, the first duct 33 corresponding to the “air supply unit” of the present invention is arranged on a part (center) of the upper part of the inside, not on the entire upper part of the inside. Thus, the air supply unit, in other words, the capacity of the inside of the first duct 33 can be smaller than in the conventional painting booth in which the entire upper part of the inside is the air supply unit. With this, even if the flow rate of the air flowing down in the painting booth 10 from the side air blow-out unit 36 is made smaller, the internal pressure in the first duct 33 does not excessively decrease like before, whereby it is possible to stably control the flow rate of air. Further, since the air is blown out from the first duct 33 to the pair of first inclined ceiling surfaces 31A and 31A on the both sides of the first duct 33 and then flows down smoothly toward the first inner surfaces 30A and 03A while being guided by the first inclined ceiling surfaces 31A and 31A, it is possible to avoid paint from attaching to the first inner surfaces 30A and 30A. In addition, air is not allowed to flow right downward from the first duct 33, and in the painting treatment area R1 right under the first duct 33, only an extremely slow air flow is generated associated with the air flowing down around the painting treatment area R1. Therefore, even a coating gun 16 having a relatively low blowing pressure of shaping air can perform high-quality painting.

### Second Embodiment

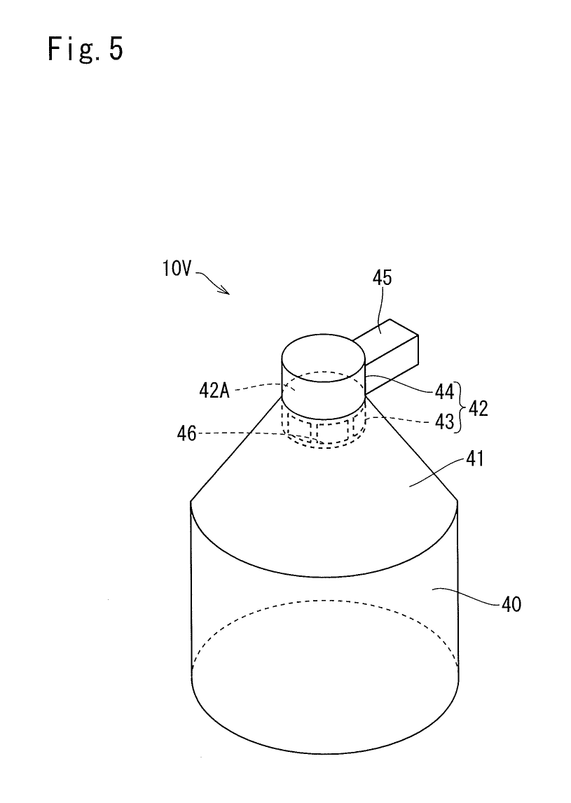

A painting booth 10V of the present embodiment is shown in FIG. 5 and is configured to be equipped with a conical ceiling wall 41 of a conical shape on the upper side of a side-part surrounding wall 40 of a cylindrical shape, and is equipped with a two-stage sleeve 42 at the central part of the conical ceiling wall 41. The two-stage sleeve 42 has a cylindrical shape which vertically penetrates through the upper end part of the conical ceiling wall 41, and has a separation plate 42A at the intermediate position, in the vertical direction, of the inside thereof. The separation plate 42A separates the two-stage sleeve 42 into an upper-stage sleeve 44 and a lower-stage sleeve 43 corresponding to the “air supply unit” of the present invention.

The separation plate 42A is equipped with an air passing part (not shown) having the same structure as that of the air passing part 37 in the first embodiment, and on the side surface of the upper-stage sleeve 44, an introduction part 45 connected to the air conditioner (not shown) is provided. Further, the lower-stage sleeve 43 corresponds to the “air supply unit” of the present invention and is equipped with a side air blow-out unit 46 on the entire part of the circumferential surface thereof. Specifically, at plural positions, in a circumferential direction, on a cylinder wall of the lower-stage sleeve 43, a plurality of rectangular windows are formed by cutting off an intermediate part except the upper and lower edge parts, and the group of rectangular windows are covered with a mesh and a filter mat (not shown), to thereby provide a side air blow-out unit 46 having the same structure as that of the side air blow-out units 36 of the first embodiment.

Also in the painting booth 10V of the present embodiment, the lower-stage sleeve 43 serving as the “air supply unit” of the present invention is disposed on a part of the upper part of the inside, and thus, the capacity of the inside of the air supply unit can be smaller than the conventional painting booth in which the entire upper part of the inside serves as the air supply unit. With this arrangement, even if the flow rate of the air flowing down in the painting booth 10V from the side air blow-out unit 46 is made smaller, the internal pressure in the air supply unit does not excessively decrease like before, whereby it is possible to stably control the flow rate of air. Further, since the conical ceiling wall 41 is provided on a surrounding area of the air supply unit, that is, the lower-stage sleeve 43 in the upper part of the inside of the painting booth 10V, air flows down smoothly on the side-part surrounding wall 40 while being guided by the conical ceiling wall 41, so that the air flow can prevent paint from attaching to the side-part surrounding wall 40 and a coating robot (not shown) adjacent to the inner side of the side-part surrounding wall 40. In addition, air is not allowed to flow right downward from the lower-stage sleeve 43, and in the painting treatment area R1 right under the lower-stage sleeve 43, only an extremely slow air flow is generated associated with the air flowing down around the painting treatment area. Therefore, even a coating gun having a relatively low blowing pressure of shaping air can perform high-quality painting.

### Other Embodiments

The present invention is not limited to the above embodiments, and, for example, embodiments described below are also included in the technical scope of the present invention. Further besides the embodiments below, the present invention can be variously modified and practiced without departing from the spirit of the invention.

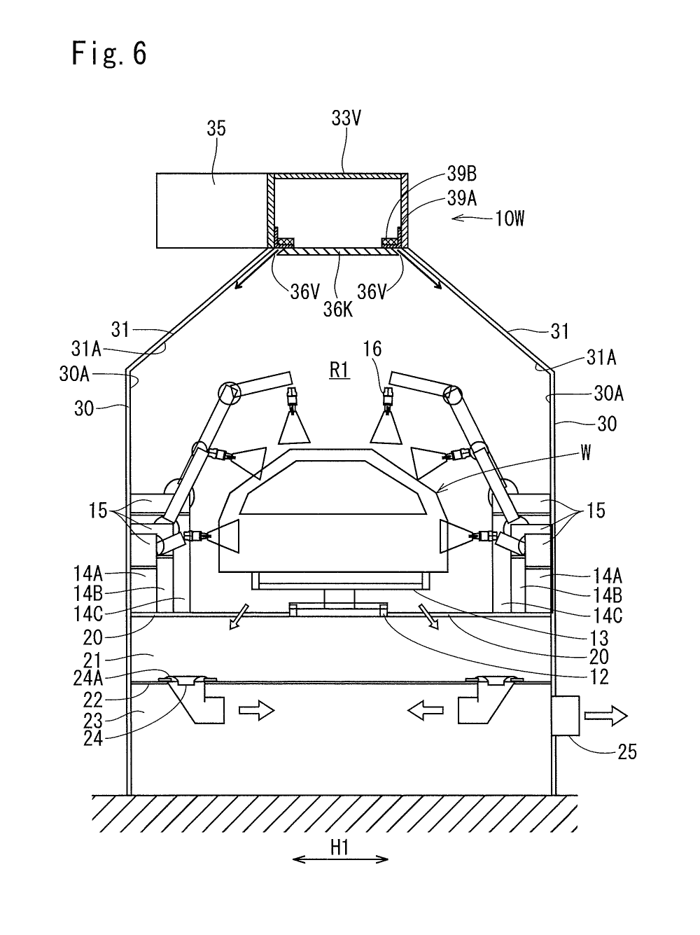

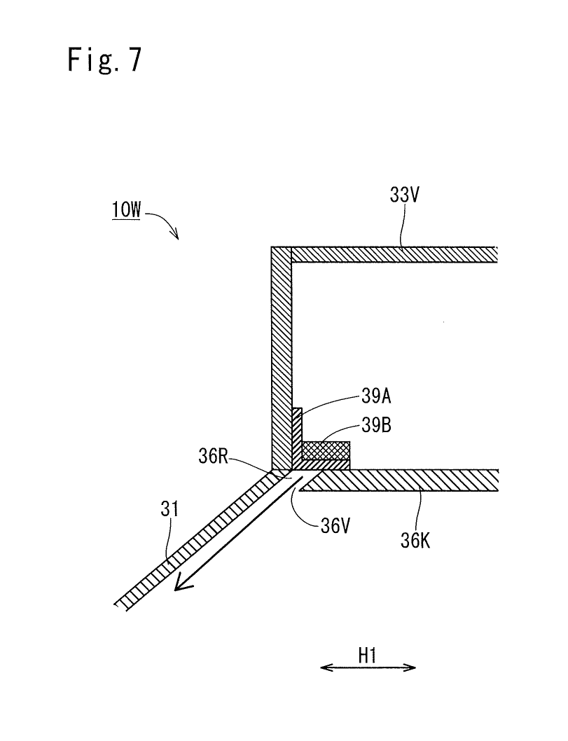

(1) In the painting booth 10 of the first embodiment, the first duct 33 corresponding to the “air supply unit” is disposed between the upper end parts of the inclined roofs 31 and 31. However, like the painting booth 10W shown in FIG. 6, a duct 33V may be provided as the “air supply unit” above the inclined roofs 31 and 31, and side air blow-out units 36V and 36V may be provided on the both edge parts on the lower surface of the duct 33V. In this case, for example, a ceiling plate 36K is provided between the upper end parts of the inclined roofs 31 and 31, and each of the both side surfaces of the ceiling plate 36K is made sloped parallel to each of the inclined roofs 31 such that air flow passages 36R and 36R are formed between the inclined roofs 31 and 31 and the ceiling plate 36K. Then, as shown in FIG. 7, the air flow passages 36R may be covered with a mesh 39A and a filter mat 39B from the inner side of the duct 33V to thereby serve as the side air blow-out units 36V.

(2) In the painting booth 10V of the second embodiment, the side-part surrounding wall 40 has a cylindrical shape and the conical ceiling wall 41 has a conical shape. However, the side-part surrounding wall may have a quadrangular cylinder shape, and the conical ceiling wall may have a pyramid shape. Further, in association with that, the lower-stage sleeve may have a quadrangular cylinder shape.

(3) A bottom air blow-out unit which blows out air downward in the vertical direction at a flow speed slower than the side air blow-out units 36 and 46 may be provided on the lower surface of the air supply unit (the first duct 33 and the lower-stage sleeve 43) of the first and second embodiments, and a gentle airflow may be created in the painting treatment area R1 by the air from the bottom air blow-out unit so as to remove excess paint around the workpiece W. Specifically, the inside of the first duct 33 may be separated by a partition wall made up of a mesh and a filter mat into an upper and a lower stages, where the side air blow-out units 36 are formed in both side surfaces on the upper stage side and the bottom air blow-out unit is formed in the lower surface on the lower stage side.

(4) In each of the above embodiments, an air-permeable pressure reduction member according to the present invention is configured with a mesh and a filter mat. However, only a mesh or a filter mat can be used, and anything other than a mesh and a filter mat can also be used if air can pass therethrough while losing pressure.

### DESCRIPTION OF THE REFERENCE NUMERAL

10, 10V, 10W: Painting booth
25: Exhaust duct
30A: First inner surface
31: Inclined roof
31A: First inclined ceiling surface
33: First duct (air supply unit, air supply duct)
33A, 39A: Mesh (air-permeable pressure reduction member)
33B, 39B: Filter mat (air-permeable pressure reduction member)
33V: Duct (air supply unit)
36, 36V, 46: Side air blow-out unit
40: Side-part surrounding wall
41: Conical ceiling wall
43: Lower-stage sleeve (air supply unit)
H1: First horizontal direction
H2: Second horizontal direction
R1: Painting treatment area
W: Workpiece

1. A painting booth having therein a painting treatment area where a workpiece is painted with atomized paint, in which air flows down from an upper part of an inside of the painting booth to remove the atomized paint that is not attached to the workpiece, the painting booth comprising:
a pair of first inner surfaces facing each other in a first horizontal direction with the painting treatment area sandwiched therebetween;
a pair of first inclined ceiling surfaces each inclined downward from a position close to a center, in the first horizontal direction, of the upper part of the inside to an upper end part of each of the pair of first inner surfaces;
an air supply duct arranged at a center, in the first horizontal direction, of the upper part of the inside; and
a side air blow-out port provided on the air supply duct and blow air against the pair of first inclined ceiling surfaces.

2. The painting booth according to claim 1, wherein
the painting booth has a planar rectangular shape which is longer in a second horizontal direction perpendicular to the first horizontal direction than in the first horizontal direction,
the air supply duct is extending in the second horizontal direction and is protruding downward from the center, in the first horizontal direction, of the upper part of the inside, and
the side air blow-out port is configured with an opening formed in a side surface of the air supply duct, the opening being covered by a filter or a mesh.

3. A painting booth having therein a painting treatment area where a workpiece is painted with atomized paint, in which air flows down from an upper part of an inside of the painting booth to remove the atomized paint that is not attached to the workpiece, the painting booth comprising:
a side-part surrounding wall which has a cylindrical shape and laterally surrounds the painting treatment area;
a conical ceiling wall which is inclined and narrowed from an entire part of an upper end of the side-part surrounding wall toward above a central part of the side-part surrounding wall,
an air supply duct arranged on a central part of an upper part of the conical ceiling wall; and
a side air blow-out port provided on the air supply duct to blow air against the conical ceiling wall.

4. The painting booth according to claim 3, wherein
the air supply duct protrudes downward from a central part of an upper end of the conical ceiling wall, and
the side air blow-out port is provided on an entire part of a side surface of the air supply duct and blows out air in an radial manner.

5. The painting booth according to claim 1, comprising
a bottom air blow-out port which is provided on a lower surface of the air supply duct and blows out air downward in a vertical direction at a flow speed slower than in the side air blow-out port.

6. The painting booth according to claim 1, comprising
a bottom air blow-out port which is provided on a lower surface of the air supply duct and blows out air downward in a vertical direction at a flow speed slower than in the side air blow-out port.

7. The painting booth according to claim 2, comprising
a bottom air blow-out port which is provided on a lower surface of the air supply duct and blows out air downward in a vertical direction at a flow speed slower than in the side air blow-out port.

8. The painting booth according to claim 3, comprising
a bottom air blow-out port which is provided on a lower surface of the air supply duct and blows out air downward in a vertical direction at a flow speed slower than in the side air blow-out port.

9. The painting booth according to claim 4, comprising
a bottom air blow-out port which is provided on a lower surface of the air supply duct and blows out air downward in a vertical direction at a flow speed slower than in the side air blow-out port.
